(19) United States
(12) Patent Application Publication
(10) Pub. No.: US 2015/0230119 A1
(43) Pub. Date: Aug. 13, 2015

(54) METHOD AND APPARATUS FOR PROVIDING MANAGED SERVICE IN WIRELESS COMMUNICATION SYSTEM

(71) Applicant: ELECTRONICS AND TELECOMMUNICATIONS RESEARCH INSTITUTE, Daejeon (KR)

(72) Inventors: Seung-Hwan LEE, Daejeon (KR); Junho LEE, Daejeon (KR); Seok SEO, Daejeon (KR); Jae Su SONG, Daejeon (KR); Yunhee CHO, Daejeon (KR)

(73) Assignee: ELECTRONICS AND TELECOMMUNICATIONS RESEARCH NSTITUTE, Daejeon (KR)

(21) Appl. No.: 14/613,728

(22) Filed: Feb. 4, 2015

(30) Foreign Application Priority Data
Feb. 12, 2014 (KR) 10-2014-0016233

(51) Int. Cl. H04W 28/02

(52) U.S. Cl. CPC H04W 28/0205; H04W 28/0268; H04W 28/0289

(57) ABSTRACT

A method and an apparatus for providing a managed service in a wireless communication system are provided. A base station receives a low-level network access mode or a high-level network access mode from a terminal, and determines a limitation or compensation corresponding to an access mode. Further, the base station provides the managed service to the terminal based on the access mode received from the terminal.

### CROSS-REFERENCE TO RELATED APPLICATION

This application claims priority to and the benefit of Korean Patent Application No. 10-2014-0016233 filed in the Korean Intellectual Property Office on Feb. 12, 2014, the entire contents of which are incorporated herein by reference.

### BACKGROUND OF THE INVENTION

(a) Field of the Invention

The present invention relates to a method and an apparatus for providing a managed service in a wireless communication system.

(b) Description of the Related Art

Propagation of smart devices such as smart phones and tablet PCs has suddenly increased, and use of various mobile services has correspondingly increased. Increasing a wireless communication network is limited and a frequency resource is also limited, and as a result, a surge of mobile traffic has become a main factor which causes a network overload. A QoS deteriorating phenomenon appears due to the network overload.

As one of solutions of the network overload, there is a method for limiting a specific mobile service having high traffic, which is a controversial issue in terms of network neutrality. Therefore, there is a need to manage a network load within a range in which the network neutrality is not damaged. A need exists for a method for allocating limited resources depending on QoS requirements for each user.

In a current wireless communication system, a base station provides a fair service to users of all terminals, which has a problem in that the users of all terminals may experience the QoS deterioration during network overload.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for providing a managed service in a wireless communication system having an advantage of preventing QoS for users of all terminals from deteriorating at a time of occurrence of a network overload.

An exemplary embodiment of the present invention provides a method for allowing a base station to provide a managed service to a terminal. The method may include: determining whether there is a need to manage a network load; transmitting a selectable access mode, which includes a first access mode and a second access mode requesting a larger number of radio resources than that of the first access mode, to the terminal if it is determined that there is a need to manage the network load; determining a limitation corresponding to the second access mode when the second access mode is received from the terminal; and providing the managed service to the terminal based on the second access mode.

The method may further include: determining compensation corresponding to the first access mode when the first access mode is received from the terminal; and providing the managed service to the terminal based on the first access mode.

The transmitting of the access mode may include transmitting the compensation or the limitation corresponding to the selectable access mode to the terminal. The compensation or the limitation may be controlled depending on a degree of the network load.

The transmitting of the access mode may include transmitting a network load state to the terminal.

The limitation may be a charge of an additional fee or non-allocation of priority when the terminal again requests the second access mode.

The compensation may be a charge cut or allocation of priority when the terminal requesting the first access mode requests the second access mode.

The transmitting of the access mode may include broadcasting the selectable access mode to the terminals of a cell belonging to the base station.

Another embodiment of the present invention provides a method for allowing a terminal to receive a managed service from a base station. The method may include: selecting one of a first access mode and a second access mode requesting a larger number of radio resources than that of the first access mode; transmitting the selected access mode to the base station; receiving a guide matter corresponding to the selected access mode; and receiving the managed service from the base station based on the selected access mode.

The guide matter may be the compensation or the limitation which corresponds to the selected access mode.

The method may further include asking for consent of a user by informing a user of a terminal of the guide matter.

The guide matter may be determined depending on a degree of a network load by the base station.

The receiving of the guide matter may include receiving whether to accept the selected access mode from the base station, and it may be determined by the base station whether the selected access mode is accepted in consideration of requirements of users of other terminals other than the network load and the terminal.

Yet another embodiment of the present invention provides a base station. The base station may include: a wireless frequency converter; and a processor configured to be connected to the wireless frequency converter and to perform control to provide a managed service to a terminal, wherein the processor receives a first access mode or a second access mode requesting a larger number of radio resources than that of the first access mode from the terminal, and provides the managed service to the terminal based on the access mode received from the terminal.

The processor may determine whether there is a need to manage a network load, and if it is determined that there is a need to manage the network load, may transmit the first access mode and the second access mode. The processor may determine compensation corresponding to the first access mode and determine a limitation corresponding to the second access mode. The processor may transmit the compensation and the limitation together with the first and second access modes.

The compensation and the limitation may be controlled depending on a degree of the network load.

The compensation may be a charge cut or allocation of priority when the terminal requesting the first access mode requests the second access mode.

The limitation may be a charge of an additional fee or non-allocation of priority when the terminal requests the second access mode, and then requests the second access mode again.

According to an exemplary embodiment of the present invention, it is possible to provide the desired grade (differentiation) service to the user by providing the user involvement-based managed service if the base station determines that there is a need to manage the network load.

According to another exemplary embodiment of the present invention, it is possible to provide the desired grade (differentiation) service to the user by allowing the base station to provide the user driven-based managed service.

### BRIEF DESCRIPTION OF THE DRAWINGS

FIG. 1 is a diagram illustrating an environment of a wireless communication system which provides a user involvement-based managed service according to an exemplary embodiment of the present invention.

FIG. 2 is an overall flowchart illustrating a method for providing a managed service according to an exemplary embodiment of the present invention.

FIG. 3 is a flowchart illustrating an operation of a base station 100 according to an exemplary embodiment of the present invention.

FIG. 4 is a flowchart illustrating an operation of terminals 210 and 220 according to an exemplary embodiment of the present invention.

FIG. 5 is a diagram illustrating one example in which the terminals 210 and 220 inform a user of a network state.

FIG. 6 is an overall flowchart illustrating a method for providing a managed service according to another exemplary embodiment of the present invention.

FIG. 7 is a flowchart illustrating an operation of terminals 210′ and 220′ according to the exemplary embodiment of the present invention of FIG. 6.

FIG. 8 is a flowchart illustrating an operation of a base station 100′ according to the exemplary embodiment of the present invention of FIG. 6.

FIG. 9 is a diagram illustrating a base station 900 according to an exemplary embodiment of the present invention.

FIG. 10 is a diagram illustrating a terminal 1000 according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a terminal may be called a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and the like, and may include functions of all or some of the MT, the MS, the AMS, the HR-MS, the SS, the PSS, the AT, the UE, and the like.

Further, a base station (BS) may be called an advanced base station (ABS), a high reliability base station (HR-BS), a nodeB, an evolved node B (eNodeB), an access point (AP), a radio access station (RAS), a base transceiver station (BTS), a mobile multihop relay (MMR)-BS, a relay station (RS) serving as a base station, a high reliability relay station (HR-RS) serving as a base station, and the like, and may also include functions of all or some of the ABS, the HR-BS, the nodeB, the eNodeB, the AP, the RAS, the BTS, the MMR-BS, the RS, the HR-RS, and the like.

Hereinafter, a method and an apparatus for providing a managed service according to an exemplary embodiment of the present invention will be described with reference to the accompanying drawings.

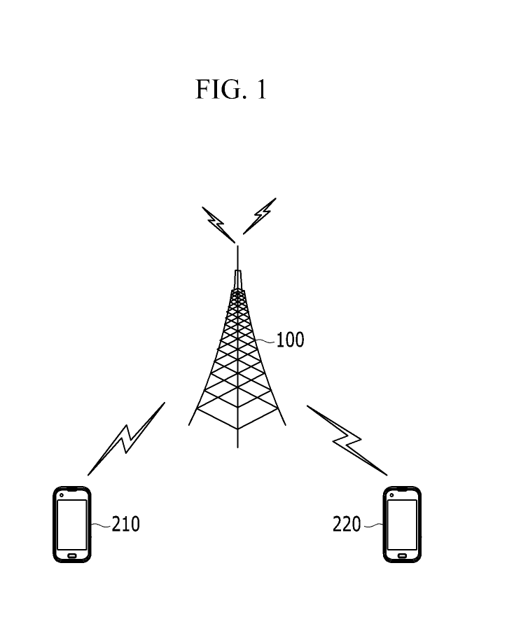

First, a method and an apparatus for providing a user involvement-based managed service according to an exemplary embodiment of the present invention will be described with reference to FIGS. 1 to 4.

FIG. 1 is a diagram illustrating environment of a wireless communication system which provides a user involvement-based managed service according to an exemplary embodiment of the present invention.

As illustrated in FIG. 1, a wireless communication system according to an exemplary embodiment of the present invention includes a base station 100 and terminals 210 and 220.

The base station 100 manages access to the terminals 210 and 220 which belong to a cell, a resource, and the like. The base station 100 according to the exemplary embodiment of the present invention performs measurement and monitoring of a network load and determines whether there is a need to manage the network load. If it is determined that there is a need to manage the network load, the base station 100 sends a query regarding whether to select a network access mode to the terminals 210 and 220 within a range in which quality of all terminals belonging to the cell does not deteriorate, and differentially allocates limited resources to the terminals 210 and 220 depending on the network access mode selected by the user of the terminals 210 and 220. As such, the base station 100 according to the exemplary embodiment of the present invention serves to provide the user involvement-based managed service. Therefore, an apparatus for providing a user involvement-based managed service according to the exemplary embodiment of the present invention may be the base station 100.

The terminals 210 and 220 are terminals belonging to the cell of the base station 100, and receive a service from the base station 100. The terminal according to the exemplary embodiment of the present invention is classified into two kinds. The terminal 210 is a terminal which requests a low-level network access mode and is a terminal which performs a least access function to the base station 100 while using a small number of radio resources. Further, the terminal 220 is a terminal which requests a high-level network access mode and is a terminal which desires to receive a service while requesting a large number of radio resources. The service requesting a large number of radio resources is a service which provides a high-quality call, a high-resolution motion picture, a high-speed file download, and the like.

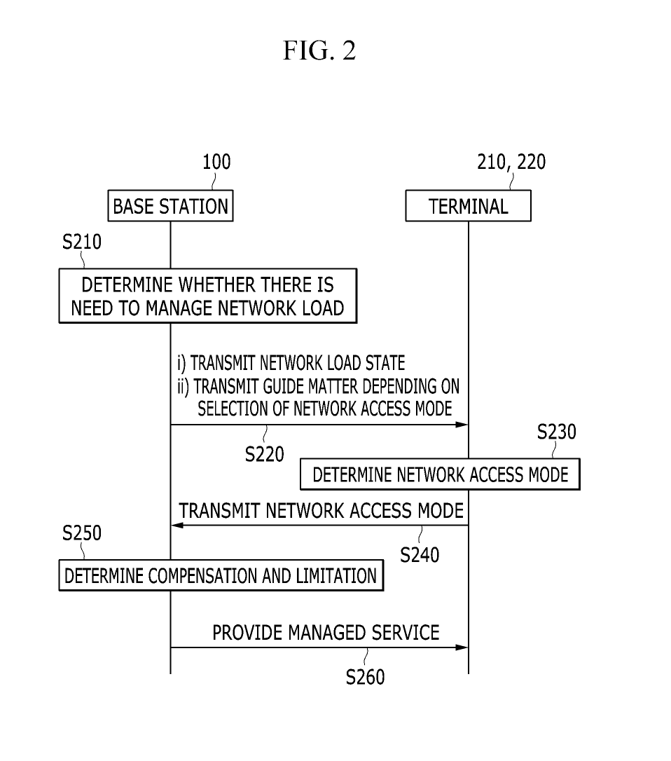

FIG. 2 is an overall flowchart illustrating a method for providing a managed service according to an exemplary embodiment of the present invention.

As illustrated in FIG. 2, the base station 100 understands traffic conditions of the terminals belonging to the cell to monitor the network load, and determines whether there is a need to manage the network load using the monitored network load (S210). The network load monitoring of the base station 100 may be periodically performed. A method for allowing a base station 100 to monitor a network load determines the traffic conditions of the terminals belonging to the cell, which may be easily appreciated by a person having ordinary skill in the art to which the present invention pertains. Therefore, a detailed description of the method will be omitted.

If it is determined that there is a need to manage the network load due to the network overload of the base station 100, a network load state and a selectable network access mode are transmitted to the terminals 210 and 220 (S220). The base station 100 also transmits guide matters depending on the selection of the network access mode (S220). The guide matters are compensation, additional fee, various limitations, or the like depending on the selection of the network access mode. That is, the base station 100 transmits the network load state and the guide matters to the terminals 210 and 220 to enable the user of the terminals 210 and 220 to select the network access mode.

Next, the user of the terminals 210 and 220 uses the network load state and the guide matters transmitted from the base station 100 to select the network access mode (S230). For example, the terminal 210 selects the low-level network access mode when the function of least access to the base station 100 is required. Further, the terminal 220 selects a high-level network access mode when a service requesting a large number of radio resources is required.

The terminals 210 and 220 transmit the selected network access mode to the base station 100 (S240). A kind of the network access mode transmitted to the base station 100 may be the low-level network access mode or the high-level network access mode which are described above.

The base station 100 determines the compensation and the limitations depending on the network access mode received from the terminals 210 and 220 (S250). Here, as the compensation and the limitations, there is a case of differentially charging a fee or a case of allocating priority at the time of the network overload state which occurs later.

Next, the base station 100 differentially provides the managed service to the terminals 210 and 220 (S260). When the terminal 210 requests the low-level network access mode, the base station 100 allocates a smallest number of radio resources to the terminal 210. Further, when the terminal 220 requests the high-level network access mode, the base station 100 allocates a large number of radio resources to the terminal 220.

As such, according to the exemplary embodiment of the present invention, it is possible to prevent a quality of service provided to the user from deteriorating by differentially providing a service depending on a user selection.

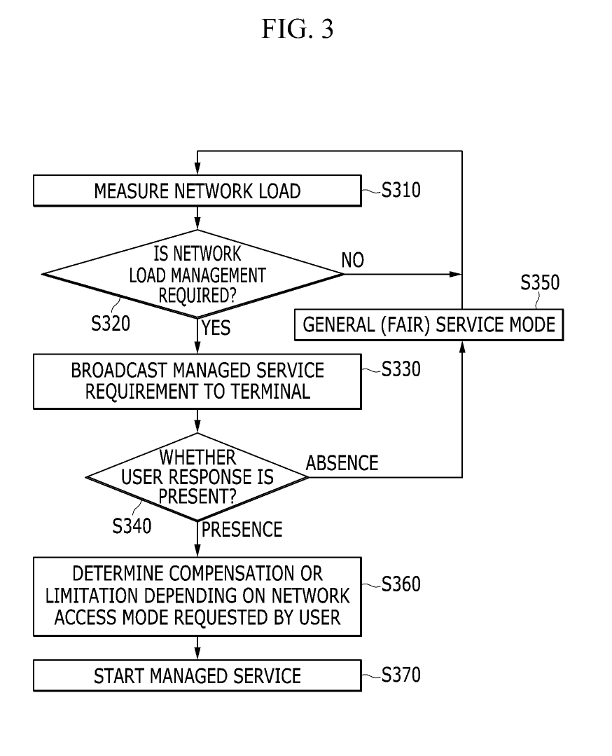

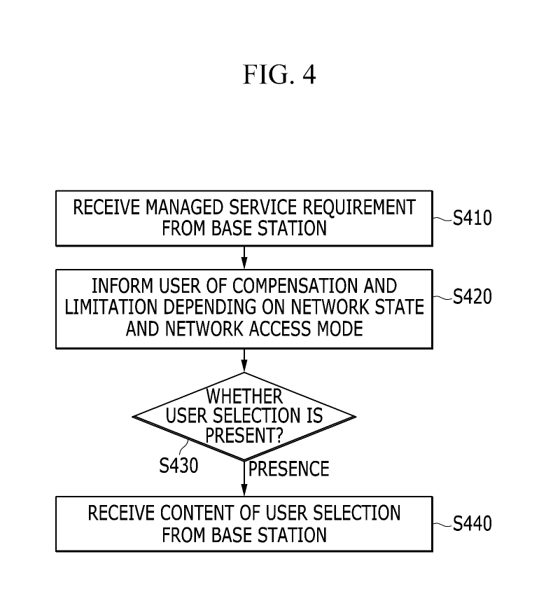

Hereinafter, an operation of the base station 100 and the terminals 210 and 220 for providing a managed service according to the exemplary embodiment of the present invention will be described in detail with reference to FIGS. 3 and 4.

FIG. 3 is a flowchart illustrating the operation of the base station 100 according to the exemplary embodiment of the present invention.

First, as illustrated in FIG. 3, the base station 100 periodically measures a network load for a cell which provides a service (S310). That is, the base station 100 monitors traffic requested from the terminals belonging to the cell to measure the network load.

The base station 100 determines whether there is a need to manage the network load based on the measured network load (S320). The base station 100 may determine that there is a need to manage the network load when the network is in an overload state. When it determines whether there is a need to manage the network load, the base station 100 may use various factors such as the number of users, an available bandwidth, and the like.

If it is determined that the network is not in an overload state and therefore there is no need to manage the network load, the base station 100 continuously measures the network load.

When it is determined that there is a need to manage the network load, the base station 100 broadcasts managed service requirements (guide matters) to the terminals (i.e., user) belonging to the cell (S330). Here, the managed service requirements may include the compensation or the limitations depending on the network load state and the network access mode. The user of the terminal 210 requesting a low level is given contents regarding the compensation (charge cut, later allocating priority) which are included in the managed service requirements and the user of the terminal 220 requesting a high level is given the limitations (collecting an additional fee, later non-allocating priority) which are included in managed service requirements.

Meanwhile, the broadcast managed service requirements may not be transmitted together with the network load state.

The base station 100 provides a general service mode when there is no response from the terminals 210 and 220 belonging to the cell (S340 and S350). Here, the general service mode is a mode which fairly allocates resources to the user.

The base station 100 determines the compensation or the limitations depending on the network access mode when there is a response from the terminals 210 and 220 (S360). The base station 100 allocates appropriate compensation (charge cut, later allocating priority, and the like) to the terminal 210 which selects the low-level network access mode. When receiving the high-level network access mode from the terminal 220, the base station 100 allocates the limitations (additional fee, later non-allocating priority) to the terminal 220.

Finally, the base station 100 reflects the access mode requested by the user of the terminals 210 and 220 to start the managed service (S370). That is, the base station 100 allocates a smallest number of radio resources to the terminal 210 which selects the low-level network access mode to provide a service, and allocates a large number of radio resources to the terminal 220 which selects the high-level network access mode to provide a rapid service.

The example of the compensation which is given to the terminal 210 selecting the low-level network access mode by the base station 100 may include a monetary charge cut and priority at the time of next requesting the high-level network access mode. Further, another compensation example may include a coupon or a point.

The example of the limitations which are given to the terminal 220 selecting the high-level network access mode by the base station 100 may include charging a monetarily additional fee and non-allocating priority at the time of next requesting the high level. Another example of the limitations may include a point cut, a coupon recovery, or the like.

Meanwhile, the base station 100 may control the compensation or the limitations depending on a degree of the network load. That is, when the degree of the network load is low, the base station 100 may reduce the degree of the compensation or the limitations. Further, when the degree of the network load is high, the base station 100 may increase the degree of the compensation or the limitations.

FIG. 4 is a flowchart illustrating the operation of the terminals 210 and 220 according to the exemplary embodiment of the present invention.

First, when the terminals 210 and 220 receive the managed service requirements (guide matters) from the base station 100 (S410), the terminals 210 and 220 inform the user of the compensation and the limitations depending on the network state and the network access mode (S420). As a method for allowing the terminals 210 and 220 to inform the user of the corresponding contents, various methods such as vibration and screen display may be applied.

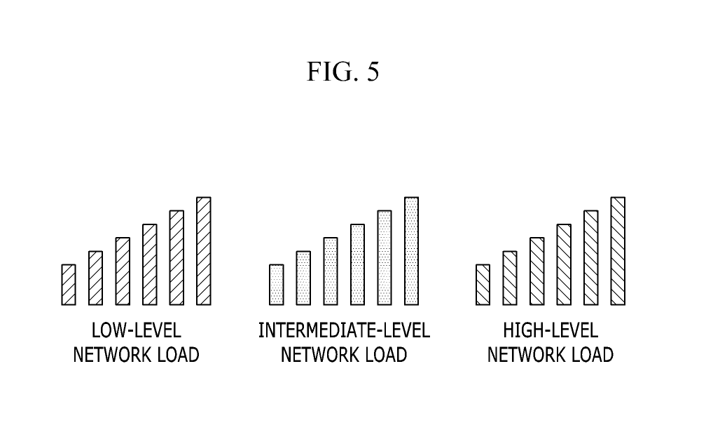

FIG. 5 is a diagram illustrating one example in which the terminals 210 and 220 inform the user of the network state. As illustrated in FIG. 5, the terminals 210 and 220 may inform a grade of the network state by a bar display color which informs of received strength.

In FIG. 5, each shaded shape corresponds to colors such as green, yellow, and red.

The terminals 210 and 220 may inform the user of the network state received from the base station 100 using an expression of character, a change in icon, and the like in addition to the method of FIG. 5.

Further, the terminals 210 and 220 may inform the user of the compensation and the limitations depending on the network access mode by various methods in a current network state.

When the user selects the network access mode, the terminals 210 and 220 transmit the network access mode selected by the user to the base station 100 (S430 and S440).

As such, according to the exemplary embodiment of the present invention, if it is determined that there is a need to manage the network load, the base station 100 performs the user involvement-based managed service which asks the user a question for the managed service and asks for consent of the user. As a result, the base station 100 according to the exemplary embodiment of the present invention may provide the desired grade (differentiation) service to the user to manage the network load.

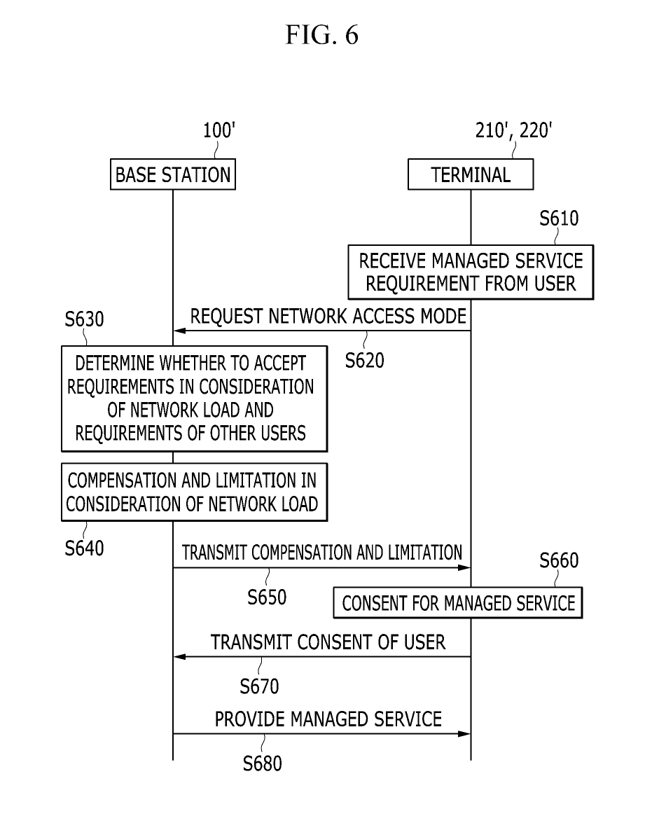

Hereinafter, a method and an apparatus for providing a user driven-based managed service according to another exemplary embodiment of the present invention will be described with reference to FIGS. 6 to 8. An environment of a wireless communication system for providing a user driven-based managed service according to the current exemplary embodiment of the present invention is the same as that in FIG. 1, and therefore a detailed description thereof will be omitted. In the method for providing a user driven-based managed service according to the current exemplary embodiment of the present invention, the terminal requesting the low-level network access mode is represented by a terminal 210′ and the terminal requesting the high-level network access mode is represented by a terminal 220′. Further, the base station which participates in the method for providing a user driven-based managed service according to the current exemplary embodiment of the present invention is represented by a base station 100′.

In the method for providing a managed service according to the current exemplary embodiment of the present invention, when the user of the terminals 210′ and 220′ wishes to receive the managed service, the terminals 210′ and 220′ recognize managed service requirements from the user in advance and transmit contents thereof to the base station 100′. Further, the base station 100′ receiving the managed service requirements from the terminals 210′and 220′ accepts the requirements to provide the managed service to users of other terminals within a cell when the received requirements are within a range in which quality of service does not deteriorate.

When not satisfying access to a desired service, the user of the terminal 220′ may request the high-level network access mode. Further, when intending to obtain the compensation while satisfying the access to the desired service, the user of the terminal 210′ may request the low-level network access mode.

FIG. 6 is an overall flowchart illustrating a method for providing a managed service according to another exemplary embodiment of the present invention.

First, the terminals 210′ and 220′ receive the managed service requirements from the user (S610). That is, the user selects the network access mode (high-level network access mode or low-level network access mode) through the terminals 210′ and 220′.

The terminals 210′ and 220′ request the network access mode selected by the user from the base station 100′ (S620). For example, the terminal 210′ requests the low-level network access mode of the base station 100′ when the function of least access to the base station 100′ is required. Further, the terminal 220′ requests the high-level network access mode of the base station 100′ when the service requesting a large number of radio resources is required.

The base station 100′ determines whether to accept the requirements of the terminals 210′ and 220′, in consideration of the network load state and requirements of other users.

The base station 100′ estimates the compensation and the limitations in consideration of the network load state, and then transmits the compensation and the limitations to the terminals 210′ and 220′ (S640 and S650).

The terminals 210′ and 220′ inform the user of the guide matters (compensation and limitations) transmitted from the base station and ask for the consent of the user (S660).

The terminals 210′ and 220′ transmit the consent of the user to the base station 100′ (S670) and the base station 100′ provides the managed service to the terminal 210′ and the terminal 220′ (S680). The base station 100′ allocates a smallest number of radio resources to the terminal 210′ requesting the low-level network access mode. Further, the base station 100′ allocates a large number of radio resources to the terminal 220′ requesting the high-level network access mode.

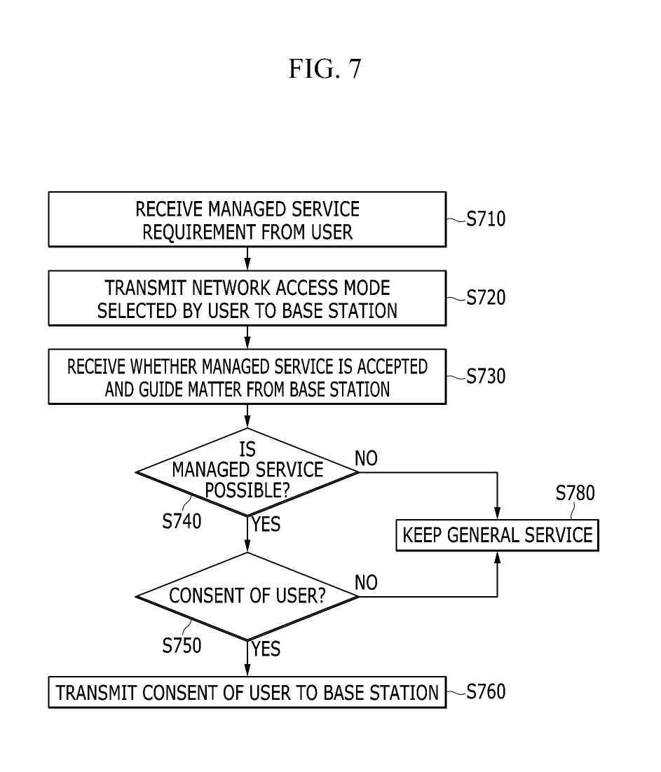

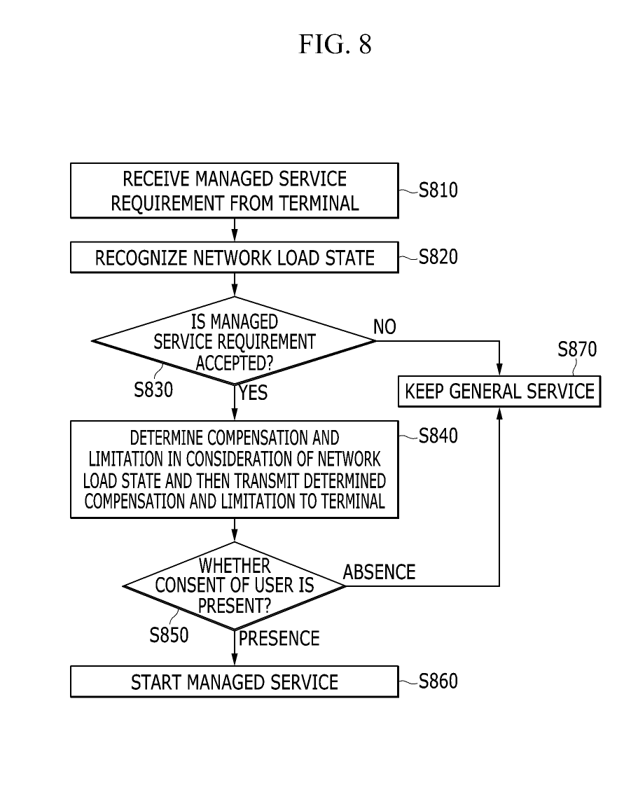

Next, the operation of the terminals 210′ and 220′ and the base station 100′ for providing a managed service according to the current exemplary embodiment of the present invention will be described in detail with reference to FIGS. 7 and 8.

FIG. 7 is a flowchart illustrating an operation of the terminals 210′ and 220′ according to the current exemplary embodiment of the present invention.

First, the terminals 210′ and 220′ receive the managed service requirements from the user (S710). That is, the user selects the network access mode (high-level network access mode or low-level network access mode) through the terminals 210′ and 220′.

The terminals 210′ and 220′ transmit the network access mode selected by the user to the base station 100′. That is, the terminal 210′ transmits the low-level network access mode to the base station 100′ and the terminal 220′ transmits the high-level network access mode to the base station 100′.

In this case, the base station 100′ determines whether to accept the requirements of the terminals 210′ and 220′, in consideration of the network load state and the requirements of other users. When accepting the requirements of the terminals 210′ and 220′, the base station 100′ estimates the guide matters (compensation, limitations, and the like) for the managed service in consideration of the network load state and then transmits the estimated guide matters.

In other words, the terminals 210′ and 220′ receive whether to accept the requirements of the terminals 210′ and 220′ and the guide matters for the managed service from the base station 100′ (S730).

The terminals 210′ and 220′ inform the user of whether to accept the managed service (requirements) and the guide matters from the base station 100′ and inform the base station 100′ of the consent of the user when there is consent of the user (S740, S750, and S760). When receiving the consent of the user from the terminals 210′ and 220′, the base station 100′ provides the managed service to the terminals 210′ and 220′. That is, the base station 100′ allocates a smallest number of radio resources to the terminal 210′ requesting the low-level network access mode and the base station 100′ allocates a large number of radio resources to the terminal 220′ requesting the high-level network access mode.

Meanwhile, when receiving the non-acceptance of the managed service from the base station 100′, the terminals 210′ and 220′ keep a general service (S740 and S780) and the terminals 210 and 220′ keep the general service even when not asking for the consent of the user (S750 and S780).

FIG. 8 is a flowchart illustrating an operation of the base station 100′ according to another exemplary embodiment of the present invention.

First, the base station 100′ receives the managed service requirements (network access mode selected by the user) of the user from the terminal 210′ (S810).

The base station 100′ measures the network load (S820) and determines whether to accept the requirements of the terminals 210′ and 220′, in consideration of the measured network load state and the requirements of other users. That is, the base station 100′ determines whether to accept the managed service requirements of the terminals 210′ and 220′ within the range in which the network load state and the QoS of other users do not deteriorate. For example, when the terminal 210′ requests the low-level network access mode, since the QoS of other users does not deteriorate, the base station 100′ may accept the low-level network access mode. However, when the terminal 220′ requests the high-level network access mode, if the user using the low-level network access mode at the corresponding time is not present, the base station 100′ may cause the situation in which the high-level network access mode may not be accepted. In this case, the base station 100′ broadcasts whether the low-level network access mode proceeds to other terminals, and when accepting the consent from other terminals, may permit the high-level network access mode for the terminal 220′.

When accepting the managed service requirements, the base station 100′ determines the compensation and the limitations in consideration of the measured network load state and transmits the determined compensation and limitations to the terminals 210′ and 220′ (S830 and S840). Here, the base station may set the degree of the limitations (additional fee, and the like) to be high as the network load is the high-level network load, and may set the degree of the compensation (charge cut, priority) to be high as the network load is the low-level network load.

Further, when receiving the consent of the managed service from the user of the terminals 210′ and 220′, the base station 100′ starts the managed service (S850 and S860). That is, the base station 100′ allocates a smallest number of radio resources to the terminal 210′ requesting the low-level network access mode, and the base station 100′ allocates a large number of radio resources to the terminal 220′ requesting the high-level network access mode.

Meanwhile, when not accepting the managed service requirements, the base station 100′ keeps the general service (S830 and S840), and when there is no consent of the user, the base station 100′ keeps the general service (S850 and S870).

As such, according to the current exemplary embodiment of the present invention, when the user of the terminals 210′ and 220′ wants the managed service, the base station 100′ determines whether to accept the managed service depending on the network load state. As a result, the base station 100′ according to the current exemplary embodiment of the present invention may provide the desired grade (differentiation) service to the user to manage the network load.

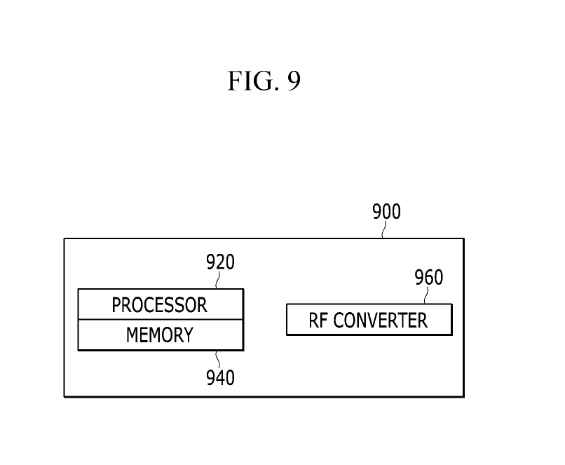

FIG. 9 is a diagram illustrating a base station 900 according to an exemplary embodiment of the present invention. The base station according to the exemplary embodiment of the present invention illustrated in FIG. 9 may be the base station 100 illustrated in FIG. 3 or the base station 100′ illustrated in FIG. 8.

As illustrated in FIG. 9, the base station 900 according to the exemplary embodiment of the present invention includes a processor 920, a memory 940, and a radio frequency (RF) converter 960. The processor 920 may be configured to implement the procedure and the methods illustrated in FIGS. 2 and 3. Further, the processor 920 may be configured to implement the procedure and the methods illustrated in FIGS. 6 and 8. The memory 940 is connected to the processor 920 and stores various kinds of information which are associated with an operation of the processor 920. The RF converter 960 is connected to the processor 920, and transmits or receives a wireless signal. Further, the base station 900 may have a single antenna or multiple antennas.

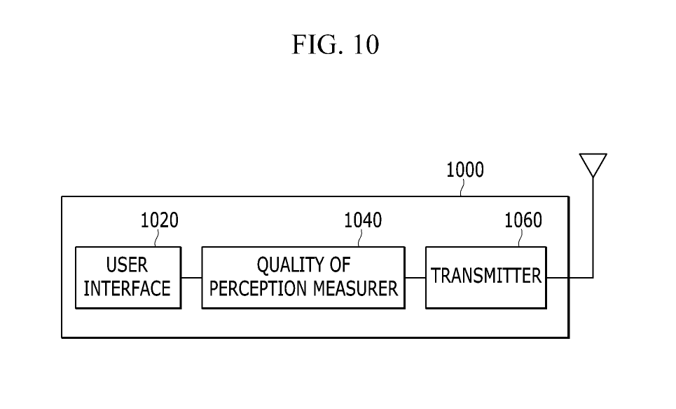

FIG. 10 is a diagram illustrating a terminal 1000 according to an exemplary embodiment of the present invention. The terminal 1000 according to the exemplary embodiment of the present invention illustrated in FIG. 10 may be the terminals 210 and 220 for providing a user involvement-based managed service illustrated in FIG. 4 and may be the terminals 210′ and 220′ for providing a user driven-based managed service illustrated in FIG. 7.

As illustrated in FIG. 10, the terminal 1000 according to the exemplary embodiment of the present invention includes a user interface 1020, a quality of perception measurer 1040, and a transmitter 1060.

The terminal 1000 receives quality of perception of a user from the user interface 1020. Here, the quality of perception of the user means satisfaction for a mobile communication service quality which is currently used by a user. The user may input the quality of perception that the user feels through the user interface 1020. Here, the user interface 1020 may be various sensors which are installed in the terminal 1000. That is, the user interface 1020 may be a touch sensor, a sound sensor, a wind sensor, a vibration sensor, or a face recognition sensor. For example, the user represents an intention for the mobile communication service quality based on a shaking degree of the terminal, and the vibration sensor senses a shaking strength or shaking frequency of the terminal.

The user interface 1020 transmits information on the quality of perception of the user received from the user to the quality of perception measurer 1040.

The quality of perception measurer 1040 measures the quality of perception of the user based on the input (i.e., information on the quality of perception of the user) of the user sensed by the user interface 1020. When the user interface 1020 is the touch sensor, the quality of perception measurer 1040 may measure the quality of perception of the user based on touch strength or touch duration. When the user interface 1020 is the sound sensor, the quality of perception measurer 1040 may measure the quality of perception of the user based on a sound size. When the user interface 1020 is the wind sensor, the quality of perception measurer 1040 may measure the quality of perception of the user based on strength of breath wind which is input from the user. When the user interface 1020 is the vibration sensor, the quality of perception measurer 1040 may measure the quality of perception of the user based on shaking strength or shaking frequency which is input from the user. That is, the quality of perception measurer 1040 may measure a speed at which the user shakes the terminal and a frequency at which the user shakes the terminal based on the vibration sensor to measure the satisfaction for the mobile communication service quality that the user feels. Further, when the user interface 102 is the face recognition sensor, the quality of perception measurer 1040 may measure the quality of perception of the user based on a face motion (for example, shape of mouth/eye) of the user. Meanwhile, the quality of perception measurer 1040 may measure the quality of perception of the user in additional consideration of a relationship between previous measurement values, time, a user position, a use pattern of a user, and the like to improve accuracy of the quality of perception of the user.

The transmitter 1060 periodically or aperiodically transmits the information on the quality of perception of the user which is measured by the quality of perception measurer 1040 to the base station 900. The base station 900 uses information on the quality of perception of the user, and the like, which is received from the terminal 1000, in a base station resource operation to improve the network load management, the managed service management, and the quality of perception.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for allowing a base station to provide a managed service to a terminal, comprising:
determining whether there is a need to manage a network load;
transmitting a selectable access mode, which includes a first access mode and a second access mode requesting a larger number of radio resources than that of the first access mode, to the terminal if it is determined that there is a need to manage the network load;
determining a limitation corresponding to the second access mode when the second access mode is received from the terminal; and
providing the managed service to the terminal based on the second access mode.

2. The method of claim 1, further comprising:
determining compensation corresponding to the first access mode when the first access mode is received from the terminal; and
providing the managed service to the terminal based on the first access mode.

3. The method of claim 1, wherein the transmitting of the access mode includes transmitting the compensation or the limitation corresponding to the selectable access mode to the terminal.

4. The method of claim 3, wherein the compensation or the limitation is controlled depending on a degree of the network load.

5. The method of claim 1, wherein the transmitting of the access mode includes transmitting a network load state to the terminal.

6. The method of claim 1, wherein the limitation is a charge of an additional fee or non-allocation of priority when the terminal again requests the second access mode.

7. The method of claim 2, wherein the compensation is a charge cut or allocation of priority when the terminal requesting the first access mode requests the second access mode.

8. The method of claim 1, wherein the transmitting of the access mode includes broadcasting the selectable access mode to the terminals of a cell belonging to the base station.

9. A method for allowing a terminal to receive a managed service from a base station, comprising:
selecting one of a first access mode and a second access mode requesting a larger number of radio resources than that of the first access mode;
transmitting the selected access mode to the base station;
receiving a guide matter corresponding to the selected access mode; and
receiving the managed service from the base station based on the selected access mode.

10. The method of claim 9, wherein the guide matter is compensation or a limitation which corresponds to the selected access mode.

11. The method of claim 9, further comprising asking for consent of a user by informing the user of the terminal of the guide matter.

12. The method of claim 9, wherein the guide matter is determined depending on a degree of a network load by the base station.

13. The method of claim 9, wherein the receiving of the guide matter includes receiving whether to accept the selected access mode from the base station and it is determined by the base station whether the selected access mode is accepted in consideration of requirements of users of other terminals other than a network load and the terminal.

14. A base station, comprising:
a wireless frequency converter; and
a processor configured to be connected to the wireless frequency converter and perform control to provide a managed service to a terminal,
wherein the processor receives a first access mode or a second access mode requesting a larger number of radio resources than that of the first access mode from the terminal, and provides the managed service to the terminal based on the access mode received from the terminal.

15. The base station of claim 14, wherein the processor determines whether there is a need to manage a network load, and if it is determined that there is a need to manage the network load, transmits the first access mode and the second access mode.

16. The base station of claim 15, wherein the processor determines compensation corresponding to the first access mode and determines a limitation corresponding to the second access mode.

17. The base station of claim 16, wherein the processor transmits the compensation and the limitation together with the first and second access modes.

18. The base station of claim 16, wherein the compensation and the limitation are controlled depending on a degree of the network load.

19. The base station of claim 16, wherein the compensation is a charge cut or allocation of priority when the terminal requesting the first access mode requests the second access mode.

20. The base station of claim 16, wherein the limitation is a charge of an additional fee or non-allocation of priority when the terminal requests the second access mode and then requests the second access mode again.

21. A terminal, comprising:
a user interface configured to sense first information corresponding to a quality of perception which is satisfaction for a mobile communication service quality of a user;
a quality of perception measurer configured to measure the quality of perception based on the first information; and
a transmitter configured to transmit information on the quality of perception to a base station.

22. The terminal of claim 21, wherein the user interface is at least one of a touch sensor, a sound sensor, a wind sensor, a vibration sensor, and a face recognition sensor.

23. The terminal of claim 22, wherein, when the user interface is the vibration sensor, the quality of perception measurer specifies the quality of perception based on shaking strength or shanking frequency of the terminal input from the user.

24. The terminal of claim 21, wherein the base station uses the information on the quality of perception in network load management or a base station resource operation.
